(19) United States
(12) Patent Application Publication
(10) Pub. No.: US 2021/0032538 A1
(43) Pub. Date: Feb. 4, 2021

(54) METHOD FOR IMPROVING TOBACCO-PLANTING SOIL BY USING BIOCHAR

(71) Applicants: Institute of Geochemistry, Chinese Academy of Sciences, Guiyang (CN); Guizhou Academy of Tobacco Science, Guiyang (CN)

(72) Inventors: Jianzhong Cheng, Guiyang (CN); Yuan Tang, Guiyang (CN); Weichang Gao, Guiyang (CN); Yi Chen, Guiyang (CN); Wenjie Pan, Guiyang (CN); Xinqing Lee, Guiyang (CN)

(21) Appl. No.: 16/825,895

(22) Filed: Mar. 20, 2020

(30) Foreign Application Priority Data
Aug. 1, 2019 (CN) 201910706259.0

(51) Int. Cl. C09K 17/04; A01C 21/00; A01G 22/45; A01G 24/23

(52) U.S. Cl. CPC C09K 17/04; A01G 24/23; A01G 22/45; A01C 21/00

(57) ABSTRACT

The present invention provides a method for improving tobacco-planting soil by using biochar, and belongs to the technical field of soil improvement. The method includes the following steps: (1) carbonizing agricultural and forestry waste to obtain biochar; (2) pulverizing the biochar to obtain a biochar particle; and (3) mixing the biochar particle with a plow layer of the tobacco-planting soil to obtain biochar-improved soil. Compared with tobacco-planting soil that is not added with the biochar (control), the method provided by the present invention greatly increases carbon and nitrogen contents of the tobacco-planting soil, and significantly increases moisture and available potassium contents of the tobacco-planting soil, which is beneficial to ensure the sorption of soil moisture and nutrients by the tobacco plant. The biochar prepared by the present invention has strong stability and can interact with the soil for a long time, and also has good effects on ameliorating soil compaction and improving the aeration performance or the like, thus helping to eliminate or reduce an environmental factor that is not conducive to the growth of tobacco caused by an obstacle of continuous cropping and significantly increase the biomass of the tobacco plant.

### TECHNICAL FIELD

The present invention belongs to the technical field of soil improvement, and particularly relates to a method for improving tobacco-planting soil by using biochar.

### BACKGROUND

Tobacco (Nicotiana tabacum L.) is one of the most important economic crops in China. The planting area and output of China's tobacco rank first in the world, and annual tobacco production is about 42% of the world. Tobacco straw (tobacco stem) is the largest by-product of tobacco production. Tobacco straw is neither suitable for use as a fuel nor suitable for directly returning to the field for use as a fertilizer. A large amount of tobacco straw is discarded or incinerated, which not only breeds a large number of germs, but also seriously pollutes the surroundings. Therefore, strengthening the comprehensive utilization of agricultural waste such as the tobacco straw can not only effectively treat the waste, turn the waste into treasure, but also increase the economic income of tobacco farmers, thus achieving sustainable development of the tobacco industry.

Soil is an important carrier for tobacco planting, providing moisture and nutrients for the growth of tobacco, and is also an important non-renewable natural resource. The output, quality and flavor of tobacco are closely related to soil nutrients, and suitable soil nutrients are an important basis for high quality and high output tobacco. However, with the development of the fertilizer industry, the application rate of organic fertilizers in the process of tobacco planting has decreased rapidly, and the long-term application of chemical fertilizers has resulted in pollution of tobacco-planting soil and a serious decline in fertility and organic matter. At the same time, continuous cropping of tobacco fields is more serious; yet, tobacco is a crop that is not suitable for continuous cropping, and long-term continuous cropping will cause compaction and nutrient imbalance of tobacco-planting soil, leading to a decrease in the uptake rate of tobacco on soil nutrients, and seriously restricting the output and quality of tobacco. Therefore, how to improve tobacco-planting soil has become a key scientific issue that the tobacco industry urgently needs to solve.

In view of the above problems arising from the tobacco-planting soil, various soil improvement methods have been adopted, including mulching cultivation, chemical improvement, green manure application, and microbial fertilizers, etc, but most of the improvement methods still have a certain limitation, and some even reduce the quality of a tobacco leaf. Soil is a special and complex environmental medium, and substances added to the soil should be improvers that are environmentally friendly, highly stable, and free of secondary pollution.

Biochar, also known as biomass charcoal, refers to a class of carbon-containing, stable, and highly aromatic solid matters obtained by pyrolysis of biomass under anoxic or anaerobic conditions. Biochar has many advantages such as a high aromatic structure, low decomposition and a high carbon content. It can be stored in the environment for a long time and is considered as a stable CO₂ sink. In recent years, biochar has been used as a natural soil improver. It has a strong adsorption property due to its looseness and porosity and large specific surface area, and can effectively adsorb pesticides and heavy metals, reduce their bioavailability, and accordingly reduce sorption and enrichment of pollutants by tobacco. However, considering the different soil types, main cultivars and climatic conditions or the like in different tobacco-planting areas in China, how to use biochar to improve the tobacco-planting soil environment in a karst area is very important.

Karst landform is one of the most vulnerable ecosystems on the planet, accounting for about 15% of the total land area of the world. It is widely distributed in the southwestern part of China, where the contradiction between people and land is prominent, the ecosystem is fragile, and the status of soil nutrients is complex due to the complex landform. Meanwhile, the region is also an important tobacco-planting region in China, where tobacco planting plays an important role in local economic development. A karst tobacco-planting area has a shallow depth of cultivated soil, a slow soil formation rate, low fertility, poor moisture and fertilizer retention capacities, scattered distribution and poor farming conditions, which seriously restricts the output and quality of a tobacco leaf.

### SUMMARY

In view of the problems in the background art, an objective of the present invention is to provide a method for improving tobacco-planting soil by using biochar.

The present invention provides a method for improving tobacco-planting soil by using biochar, including the following steps:

(1) carbonizing agricultural and forestry waste to obtain biochar;

(2) pulverizing the biochar to obtain a biochar particle; and

(3) mixing the biochar particle with a plow layer of the tobacco-planting soil to obtain biochar-improved soil.

Preferably, in the step (1), the agricultural and forestry waste includes one or more of tobacco straw, corn straw, rape straw, rice straw, peanut shell, wood chip and Chinese medicine residue.

Preferably, in the step (1), the carbonization method includes: placing the agricultural and forestry waste in an environment of 350-600° C. for 4-6 min.

Preferably, in the step (2), the biochar particle has a particle size of <2 mm.

Preferably, in the step (3), the type of the tobacco-planting soil includes one or more of yellow soil, red soil, brown soil, cinnamon soil, black soil, chestnut soil, desert soil, moisture soil, irrigation-silted soil, paddy soil, saline-alkali soil, lithiologic soil and alpine soil.

Preferably, in the step (3), the plow layer of the tobacco-planting soil is a soil layer of 10-30 cm below a ground surface of the tobacco-planting soil.

Preferably, in the step (3), the ratio of the mixing is: 1-60 t of the biochar particle per 1 ha of the tobacco-planting soil.

Preferably, the step (3) further includes naturally fermenting and decomposing after mixing the biochar particle with the plow layer of the tobacco-planting soil, the time of the natural fermentation and decomposition being 5-7 d.

Preferably, the step (3) further includes transplanting a tobacco seedling after obtaining the biochar-improved soil; the transplanting a tobacco seedling adopts a well type seedling transplanting method, and the depth of a well for the well type seedling transplanting is 18-20 cm.

Preferably, when a central leaf of a tobacco plant is raised 2-3 cm above a wellhead, the biochar-improved soil is used to fill and seal the well.

Beneficial Effects: The present invention provides a method for improving tobacco-planting soil by using biochar, including the following steps: (1) carbonizing agricultural and forestry waste to obtain biochar; (2) pulverizing the biochar to obtain a biochar particle; and (3) mixing the biochar particle with a plow layer of the tobacco-planting soil to obtain biochar-improved soil. Compared with tobacco-planting soil that is not added with the biochar (control), the method provided by the present invention greatly increases carbon and nitrogen contents of the tobacco-planting soil. After the tobacco-planting soil is improved by the biochar, the carbon and nitrogen contents of the tobacco-planting soil increase by 7.6%-119.5% and 7.9%-41.3%, respectively, and the effect is obvious. At the same time, the addition of the biochar also significantly increases moisture and available potassium contents of the tobacco-planting soil, which is beneficial to ensure the sorption of soil moisture and nutrients by the tobacco plant. Compared with the control, the biochar increases the moisture and available potassium contents of the tobacco-planting soil in a karst area by 1.6%-18.9% and 36.8%-531.2%, respectively, and the effect is significant. In addition, the biochar prepared by the present invention has strong stability and can interact with the soil for a long time, and also has good effects on ameliorating soil compaction and improving the aeration performance or the like, thus helping to eliminate or reduce an environmental factor that is not conducive to the growth of tobacco caused by an obstacle of continuous cropping and significantly increase the biomass of the tobacco plant. Compared with the control, the biochar increases the biomass of the tobacco plant by 44.8%-98.3%.

### BRIEF DESCRIPTION OF THE DRAWINGS

FIG. 1 is a diagram showing an effect of biochar application on a moisture content of tobacco-planting soil in a karst area according to Embodiment 1 of the present invention;

FIG. 2 is a diagram showing an effect of biochar application on a carbon content of tobacco-planting soil according to Embodiment 1 of the present invention;

FIG. 3 is a diagram showing an effect of biochar application on a nitrogen content of tobacco-planting soil according to Embodiment 1 of the present invention;

FIG. 4 is a diagram showing an effect of biochar application on an available potassium content of tobacco-planting soil according to Embodiment 1 of the present invention; and

FIG. 5 is a diagram showing an effect of biochar application on biomass of tobacco-planting soil according to Embodiment 1 of the present invention.

### DETAILED DESCRIPTION

The present invention provides a method for improving tobacco-planting soil by using biochar, including the following steps:

(1) carbonize agricultural and forestry waste to obtain biochar;

(2) pulverize the biochar to obtain a biochar particle; and

(3) mix the biochar particle with a plow layer of the tobacco-planting soil to obtain biochar-improved soil.

The present invention prepares the biochar by firstly using agricultural and forestry waste as a raw material, then initially processing to obtain a pulverized biomass raw material, and carbonizing. In the present invention, the agricultural and forestry waste preferably includes one or more of tobacco straw, corn straw, rape straw, rice straw, peanut shell, wood chip and Chinese medicine residue, and is more preferably tobacco straw. In the present invention, the agricultural and forestry waste is preferably sequentially subjected to impurity removal, concentrated sun or air drying and pulverization to obtain a biomass raw material having a length of ≤10 cm. The present invention has no special limit to the specific methods of the impurity removal, the concentrated sun or air drying and the pulverization, and conventional operations in the art can be used. In the present invention, the biomass raw material is carbonized to obtain the biochar. The temperature of the carbonization treatment is preferably 350-600° C., more preferably 450° C.; the time of the carbonization treatment is preferably 4-6 min, more preferably 5 min.

After obtaining the biochar, the present invention pulverizes the biochar to obtain the biochar particle. The present invention has no special limit to the specific method of the pulverization, and a conventional operation in the art can be used. In the present invention, the biochar has a particle size of preferably ≤2 mm, and more preferably ≤1 mm.

The present invention mixes the biochar particle with the plow layer of the tobacco-planting soil to obtain the biochar-improved soil. In the present invention, the tobacco-planting soil is preferably tobacco-planting soil in a karst area; the type of the tobacco-planting soil preferably includes one or more of yellow soil, red soil, brown soil, cinnamon soil, black soil, chestnut soil, desert soil, moisture soil, irrigation-silted soil, paddy soil, saline-alkali soil, lithiologic soil and alpine soil. In the present invention, the plow layer of the tobacco-planting soil is preferably a soil layer of 10-30 cm below a ground surface of the tobacco-planting soil, and more preferably a soil layer of 20 cm below the ground surface of the tobacco-planting soil. In the present invention, the ratio of the mixing is preferably: 1-60 t of the biochar particle per 1 ha of the tobacco-planting soil, and more preferably 50 t of the biochar particle per 1 ha of the tobacco-planting soil. The present invention has no special limit to the specific method of the mixing, and a conventional artificial or mechanical method like tillage can be used. In the present invention, naturally fermenting and decomposing is preferably further included after the mixing. In the present invention, the time of the natural fermentation and decomposition is preferably 5-7 d, and more preferably 6 d. After obtaining the biochar-improved soil, the present invention preferably uses the biochar-improved soil to transplant a tobacco seedling. In the present invention, the transplanting a tobacco seedling preferably adopts a well type seedling transplanting method, and the depth of a well for the well type seedling transplanting is preferably 18-20 cm. In the present invention, when a central leaf of a tobacco plant is raised 2-3 cm above a wellhead, the biochar-improved soil is preferably used to fill and seal the well.

The method for improving tobacco-planting soil in a karst area provided by the present invention prepares the biochar by using a carbonization pyrolysis method, regulates the application time, application rate and application depth of the biochar, uniformly mixes the biochar with the plow layer of the soil, and then transplants the tobacco seedling by using a well type seedling transplanting technology. The present invention has the following beneficial effects.

The biochar used in the present invention has a simple preparation process and is easy to be industrialized; such agricultural and forestry waste as tobacco straw, rape straw, corn straw and rice straw can be used as raw materials, and the raw materials are sufficient and the cost is low, which is of great significance to ecological environment protection.

The biochar used in the present invention has the features of an aromatic structure, high stability, looseness and porosity, a high nutrient content and a strong cation exchange capacity, and these features constitute a long-term environmental effect and ecological effect after the biochar is applied into the soil, remarkably improving the quality and productivity of the soil, providing a good soil environment for the crop of tobacco, and helping to improve the biomass of the tobacco plant. In addition, the biochar has a large specific surface area and an abundant surface functional group, which enable a strong adsorption capacity for such pollutants as soil pesticides and heavy metals, and are beneficial for reducing the bioavailability of the pollutants and improving the quality and safety of a tobacco leaf.

The present invention has high efficiency, a low cost, a low environmental risk and no secondary pollution, and is beneficial for reducing greenhouse gas emissions and improving the tobacco-planting soil environment. At the same time, the present invention has high practical applicability and an operation process that is easy for a farmer to grasp by training, can be widely promoted in a tobacco-planting area, and has a good prospect of application in the market.

The following describes the technical solutions provided by the present invention in detail below with reference to embodiments, but the embodiments may not be construed as a limitation to the protection scope of the present invention.

### Embodiment 1

(1) Sequentially subject tobacco straw waste to impurity removal, concentrated sun drying, air drying and pulverization to obtain a biomass raw material having a length of ≤10 cm, and then carbonize by a carbonization furnace at a holding temperature of about 350-600° C. and a standing time of 4-6 min, to finally realize complete carbonization of the tobacco straw to prepare tobacco straw biochar.

(2) Naturally air-dry the above tobacco straw biochar, then pulverize, and screen according to a particle size of ≤1 mm.

(3) Plow and finely break a tobacco field, and then artificially apply a selected biochar particle to the finely broken soil, the application rates being 1, 10, 25, 50 t/ha, respectively, and the application depth being 20 cm of a plow layer; fully and uniformly mix, so that the biochar is completely mixed with soil; then decompose in the field for 6 d, to furthest ensure the uniform distribution of the biochar in the tobacco field; and finally, ridge the biochar-improved soil, and transplant a tobacco seedling by using a well type seedling transplanting technology, the tobacco variety for experiment being tobacco K326.

Increase rates of soil moisture, carbon, nitrogen, available potassium and biomass are calculated as follows:

$$Increase rate ( \% ) = \frac{{C}_{2} - {C}_{1}}{{C}_{1}} \times 100 \%$$

where C₁ represents moisture, carbon, nitrogen, available potassium, and biomass of a tobacco plant in unimproved soil, and C₂ represents moisture, carbon, nitrogen, available potassium and biomass of a tobacco plant in biochar-improved soil.

Experimental Results:

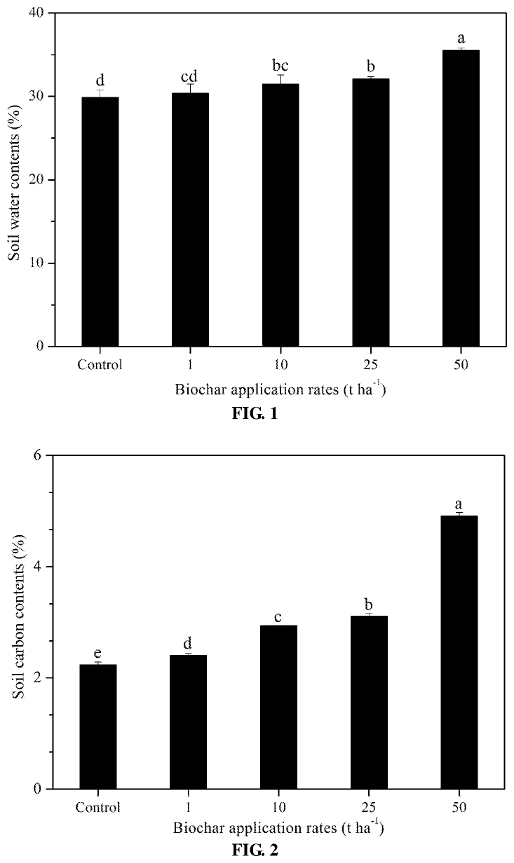

1) An effect of biochar application on the increase of a moisture content of tobacco-planting soil in a karst area is shown in FIG. 1, which indicates that:

with the increase of a biochar application rate, the moisture content of the tobacco-planting soil gradually increased, and except the insignificant difference between a treatment with the biochar application rate of 1 t/ha and a treatment not applied with the biochar (control), the difference was significant between the other treatments applied with the biochar and the treatment not applied with the biochar (p<0.05); when the application rates of the biochar in the soil were 1, 10, 25 and 50 t/ha, respectively, the increase rates of the moisture content of the tobacco-planting soil were 1.6%, 5.4%, 7.4% and 18.9%, respectively; it can be seen that with the method of the present embodiment, the increase of the moisture content of the tobacco-planting soil was obvious, especially when the application rate of the biochar was 50 t/ha, the increase rate of the moisture content of the tobacco-planting soil was as high as 18.9%, and the moisture content of the tobacco-planting soil was significantly increased compared with the other treatments.

2) An effect of the biochar application on the increase of a carbon content of the tobacco-planting soil is shown in FIG. 2, which indicates that:

with the increase of the biochar application rate, the carbon content of the tobacco-planting soil gradually increased, and the difference was significant between different biochar treatments (p<0.05); when the application rates of the biochar in the soil were 1, 10, 25 and 50 t/ha, respectively, the increase rates of the carbon content of the tobacco-planting soil were 7.6%, 31.4%, 39.1% and 119.5%, respectively; it can be seen that with the method of the present embodiment, the increase of the carbon content of the tobacco-planting soil was obvious, especially when the application rate of the biochar was 50 t/ha, the increase rate of the carbon content of the tobacco-planting soil was as high as 119.5%, and the increase rate was more significant than the other treatments.

3) An effect of the biochar application on the increase of a nitrogen content of the tobacco-planting soil is shown in FIG. 3, which indicates that:

with the increase of the biochar application rate, the nitrogen content of the tobacco-planting soil gradually increased, and except the insignificant difference between the treatment with the biochar application rate of 1 t/ha and the treatment not applied with the biochar (control), the difference was significant between the other treatments applied with the biochar and the treatment not applied with the biochar (p<0.05); when the application rates of the biochar in the soil were 1, 10, 25 and 50 t/ha, respectively, the increase rates of the nitrogen content of the tobacco-planting soil were 7.9%, 23.3%, 25.8% and 41.3%, respectively; it can be seen that with the method of the present embodiment, the increase of the nitrogen content of the tobacco-planting soil was obvious, especially when the application rate of the biochar was 50 t/ha, the increase rate of the nitrogen content of the tobacco-planting soil was as high as 41.3%, and the increase rate was more obvious than the other treatments.

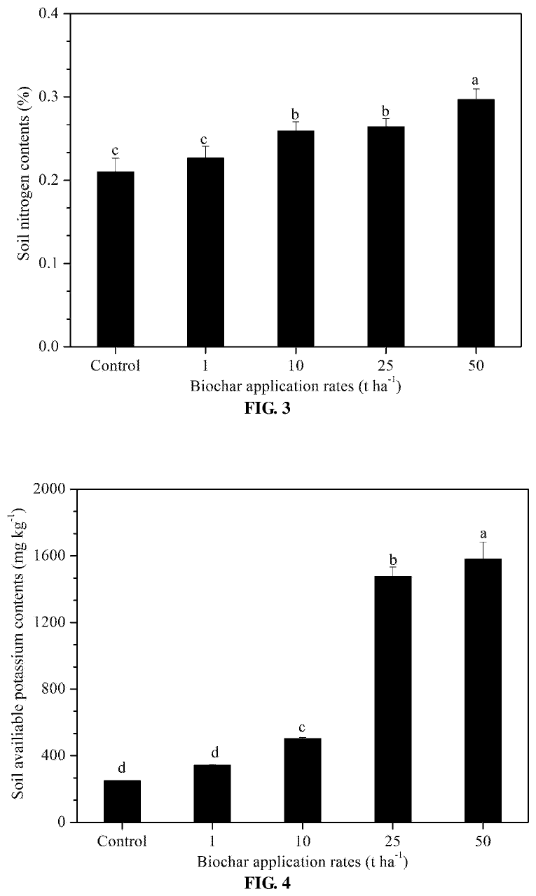

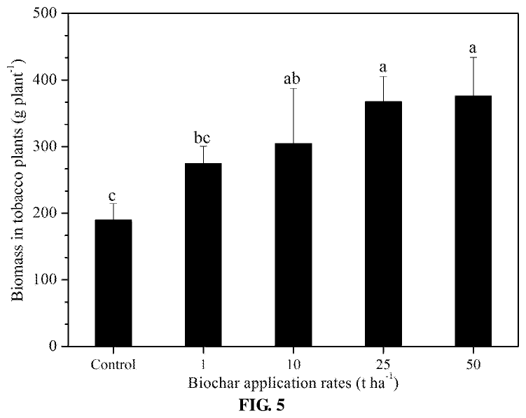

4) An effect of the biochar application on the increase of an available potassium content of the tobacco-planting soil is shown in FIG. 4, which indicates that:

with the increase of the biochar application rate, the available potassium content of the tobacco-planting soil gradually increased, and except the insignificant difference between the treatment with the biochar application rate of 1 t/ha and the treatment not applied with the biochar (control), the difference was significant between the other treatments applied with the biochar and the treatment not applied with the biochar (p<0.05); when the application rates of the biochar in the soil were 1, 10, 25 and 50 t/ha, respectively, the increase rates of the available potassium content of the tobacco-planting soil were 36.8%, 100.3%, 489.0% and 531.2%, respectively; it can be seen that with the method of the present embodiment, the increase of the available potassium content of the tobacco-planting soil was obvious, especially when the application rate of the biochar was 50 t/ha, the increase rate of the available potassium content of the tobacco-planting soil was as high as 531.2%, and the increase rate was more obvious than the other treatments.

5) An effect of the biochar application on the increase of biomass of a tobacco plant is shown in FIG. 5, which indicates that:

with the increase of the biochar application rate, the biomass of the tobacco plant gradually increased, and except the insignificant difference between the treatment with the biochar application rate of 1 t/ha and the treatment not applied with the biochar (control), the difference was significant between the other treatments applied with the biochar and the treatment not applied with the biochar (p<0.05); when the application rates of the biochar in the soil were 1, 10, 25 and 50 t/ha, respectively, the increase rates of the biomass of the tobacco plant were 44.8%, 60.7%, 93.8% and 98.3%, respectively; it can be seen that with the method of the present embodiment, the increase of the biomass of the tobacco plant was obvious, especially when the application rate of the biochar was 50 t/ha, the increase rate of the biomass of the tobacco plant was as high as 98.3%, and the increase rate was obvious.

In summary, the present invention significantly increases the moisture content, the carbon content, the nitrogen content and the available potassium content of the tobacco-planting soil, and also significantly increases the biomass of the tobacco plant, providing a good ecological environment for the growth of the tobacco plant, and contributing to the high quality and high output of a tobacco leaf; the present invention has a simple operation, a low cost, high efficiency, and a high value for promotion and application.

The above descriptions are only a preferred embodiment of the present invention. It should be noted that a person of ordinary skill in the art may further make several improvements and modifications without departing from the principle of the present invention, but these improvements and modifications shall also be deemed as falling within the protection scope of the present invention.

1. A method for improving tobacco-planting soil by using biochar, comprising the following steps:
(1) carbonizing agricultural and forestry waste to obtain biochar;
(2) pulverizing the biochar to obtain a biochar particle; and
(3) mixing the biochar particle with a plow layer of the tobacco-planting soil to obtain biochar-improved soil.

2. The method according to claim 1, wherein in the step (1), the agricultural and forestry waste comprises one or more of tobacco straw, corn straw, rape straw, rice straw, peanut shell, wood chip and Chinese medicine residue.

3. The method according to claim 1, wherein in the step (1), the carbonization method comprises: placing the agricultural and forestry waste in an environment of 350-600° C. for 4-6 min.

4. The method according to claim 1, wherein in the step (2), the biochar particle has a particle size of 2 mm.

5. The method according to claim 1, wherein in the step (3), the type of the tobacco-planting soil comprises one or more of yellow soil, red soil, brown soil, cinnamon soil, black soil, chestnut soil, desert soil, moisture soil, irrigation-silted soil, paddy soil, saline-alkali soil, lithiologic soil and alpine soil.

6. The method according to claim 1, wherein in the step (3), the plow layer of the tobacco-planting soil is a soil layer of 10-30 cm below a ground surface of the tobacco-planting soil.

7. The method according to claim 1, wherein in the step (3), the ratio of the mixing is: 1-60 t of the biochar particle per 1 ha of the tobacco-planting soil.

8. The method according to claim 1, wherein the step (3) further comprises naturally fermenting and decomposing after mixing the biochar particle with the plow layer of the tobacco-planting soil, the time of the natural fermentation and decomposition being 5-7 d.

9. The method according to claim 1, wherein the step (3) further comprises transplanting a tobacco seedling after obtaining the biochar-improved soil; the transplanting a tobacco seedling adopts a well type seedling transplanting method, and the depth of a well for the well type seedling transplanting is 18-20 cm.

10. The method according to claim 9, wherein when a central leaf of a tobacco plant is raised 2-3 cm above a wellhead, the biochar-improved soil is used to fill and seal the well.
